(19) United States
(12) Patent Application Publication
(10) Pub. No.: US 2025/0342378 A1
(43) Pub. Date: Nov. 6, 2025

(54) CIRCUIT CUTTING AID USING RECURRENT PATTERN RECOGNITION

(71) Applicant: Dell Products L.P., Round Rock, TX (US)

(72) Inventors: Miguel Paredes Quiñones, Campinas (BR); Rômulo Teixeira de Abreu Pinho, Niterói (BR)

(21) Appl. No.: 18/345,287

(22) Filed: Jun. 30, 2023

Related U.S. Application Data
(60) Provisional application No. 63/383,323, filed on Nov. 11, 2022.

(51) Int. Cl. G06N 10/20

(52) U.S. Cl. CPC G06N 10/20

(57) ABSTRACT

Cutting quantum circuits is disclosed. A graph representation of a quantum circuit includes layers. Vector layers, each of which represents a subgraph of the graph, are generated from the layers. The vector layers are sequentially input to a model that is configured to generate a probability for the vector layer and the corresponding graph layer. The probability represents whether the layer is a good cutting point for cutting the quantum circuit. A cutting operation may be performed to cut the quantum circuit at the cutting points.

### FIELD OF THE INVENTION

Embodiments of the present invention generally relate to quantum computing and to orchestrating quantum workloads. More particularly, at least some embodiments of the invention relate to systems, hardware, software, computer-readable media, and methods for cutting quantum circuits in a manner that uses recurrent pattern recognition.

### BACKGROUND

Executing quantum circuits in quantum computing systems can be both complicated and time consuming for a variety of different reasons. Various difficulties exist with regard to quantum computing. For example, the quantum circuit may be too large for available quantum hardware. Further, even if the necessary quantum hardware exists, the quantum circuit may need to wait until the resources are free.

More specifically, when using real quantum hardware, the number of qubits is often limiting and, from a practical perspective, cannot execute quantum circuits with more qubits. Further, larger quantum hardware (comparatively more qubits) may be less accurate compared to quantum hardware with fewer qubits.

There are also problems associated with simulated quantum systems. As the complexity of a quantum circuit increases (e.g., more qubits required), the amount of resources required in the simulated quantum system increases exponentially. These issues complicate the ability to effectively and efficiently use quantum computing systems, whether real or simulated.

Further, executing the quantum circuit in a quantum computing system is preceded and/followed by various operations that may also consume substantial amounts of computing resources and time. For example, prior to executing a quantum circuit, a cutting operation may be performed to cut the quantum circuit into smaller quantum circuits. When the cutting operation is performed, a knitting operation is necessary to knit the results of the various executions together to determine a result for the original quantum circuit.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of orchestrating the execution of quantum jobs and of executing quantum jobs;

FIG. 2 discloses additional aspects of executing a quantum job in a manner that accounts for recurrent patterns;

FIG. 3 illustrates a graph representation of a quantum circuit;

FIG. 4 discloses aspects of generating vector layers from layers of a graph, wherein each of the vector layers represents multiple layers of the graph and each vector layer corresponds to a layer of the graph;

FIG. 5A discloses aspects of training a recurrent machine learning model;

FIG. 5B discloses aspects of inputting vector layers into the recurrent model to generate a probability that represents whether the corresponding layer is a good candidate for cutting the quantum circuit; and

FIG. 6 discloses aspects of generating probabilities for each of the layers of a graph and cutting the quantum circuit based on the probabilities of the layers.

### DETAILED DESCRIPTION OF SOME EXAMPLE EMBODIMENTS

Embodiments of the present invention generally relate to real and/or simulated quantum computing systems and to operations performed when executing quantum workloads. More particularly, at least some embodiments of the invention relate to systems, hardware, software, computer-readable media, and methods for orchestrating quantum jobs (i.e., quantum workloads) that may include quantum circuit(s). More specifically, embodiments of the invention relate to cutting quantum circuits into quantum subcircuits (each a quantum circuit on its own) in a manner that is based on the probability that a layer is a suitable location for cutting the quantum circuit. Embodiments of the invention generate the probabilities in part using a model configured to perform recurrent pattern recognition. This allows the model to recognize cutting points (locations or layers of a quantum circuit at which cutting is likely to be successful).

Quantum circuits may be executed in simulated quantum systems (e.g., virtual quantum systems or units (vQPUs)) that include classical computing components (e.g., processors, memory) or real quantum hardware systems or units (QPUs). More specifically, the execution of quantum jobs often requires both classical computing systems and quantum computing systems because several operations are performed. Some of the operations are performed in classical computing systems and some of the operations are performed in quantum computing systems, whether real or simulated. Embodiments of the invention relate to orchestrating the operations performed in classical computing systems and in quantum computing systems.

Circuit cutting is an orchestration task or operation that is performed when a quantum circuit cannot run on a quantum system, whether real or virtual, or for other reasons. The cutting operation allows the execution of large quantum circuits across different quantum systems. More specifically, the cutting operation allows multiple quantum hardware and/or simulation engines (QPUs and vQPUs) to execute large quantum circuits by cutting the original quantum circuit into smaller quantum circuits (quantum subcircuits). The quantum subcircuits can be executed sequentially on a particular quantum computing system, in parallel using multiple quantum computing systems, or combinations thereof.

In one example, a quantum job, which includes a quantum circuit, may be received at an orchestration engine that is configured to orchestrate the execution of the quantum job. Orchestrating the execution of the quantum circuit includes performing actions or operations such as, but not limited to, transpilation operations, cutting operations, and knitting operations. These operations are orchestrated as necessary and in the appropriate order.

Circuit cutting or a cutting operation is the process of dividing a quantum circuit into smaller quantum circuits or subcircuits. Circuit cutting provides several benefits. As previously stated, the amount of classical computing resources required to simulate a quantum system increases exponentially as the size of the quantum circuit increases. Because the quantum subcircuits are smaller, the amount of resources required to execute a smaller circuit is decreased.

Cutting a quantum circuit is a combinatorial problem (the cutting problem) that scales exponentially and is performed using classical computing resources. Because the cutting problem is solved via classic computation on classical infrastructure, enabling more efficient execution of cutting operations improves the overall quantum job orchestration process.

When orchestrating the execution of quantum circuits, attempts to optimize some of these quantum related operations (e.g., transpilation, cutting, knitting) may generate conflicts. For example, knitting operations become complex and resource intensive as the number of circuits to be knit together increase. As a consequence, one aspect of optimizing knitting operations is to reduce the number of quantum subcircuits to be knitted together. In contrast to optimizing knitting operations, increasing the number of quantum subcircuits is beneficial for cutting operations because smaller quantum subcircuits consume or require fewer computing resources.

In order to determine whether a quantum circuit can be cut into smaller quantum circuits, the cutting operation is performed to completion. Due to the combinatorial nature of the cutting operation, the cutting operation can consume substantial resources and may require a significant amount of time. Embodiments of the invention relate to reducing the size or complexity of the cutting operation. This allows the cutting operation to be performed more efficiently and faster.

Embodiments of the invention use a machine learning model to identify layers or locations (a cutting point) in the quantum circuit that are likely to result in a successful cutting operation. This allows other potential solutions to be discarded. In other words, embodiments of the invention optimize the cutting operation by discarding solutions that are unlikely to be good solutions prior to cutting the quantum circuit.

Knowing whether a circuit can be cut, conventionally, depends on running the cutting algorithm to completion. Due to the combinatorial nature of the circuit cutting problem, cutting heuristics can take a very long time to run. Circuit cutting heuristics typically receive, as input, the number of qubits the resulting subcircuits should have and the number of subcircuits to generate, although other constraints may also be provided. One possible outcome of the heuristic is that no cutting solution can be found to satisfy constraints of the cutting problem. As a result, determining if a circuit cutting problem is unfeasible with a heuristic solution may require a heavy computational effort. Embodiments of the invention overcome this concern by identifying cutting points that are more likely to result in a successful cutting operation.

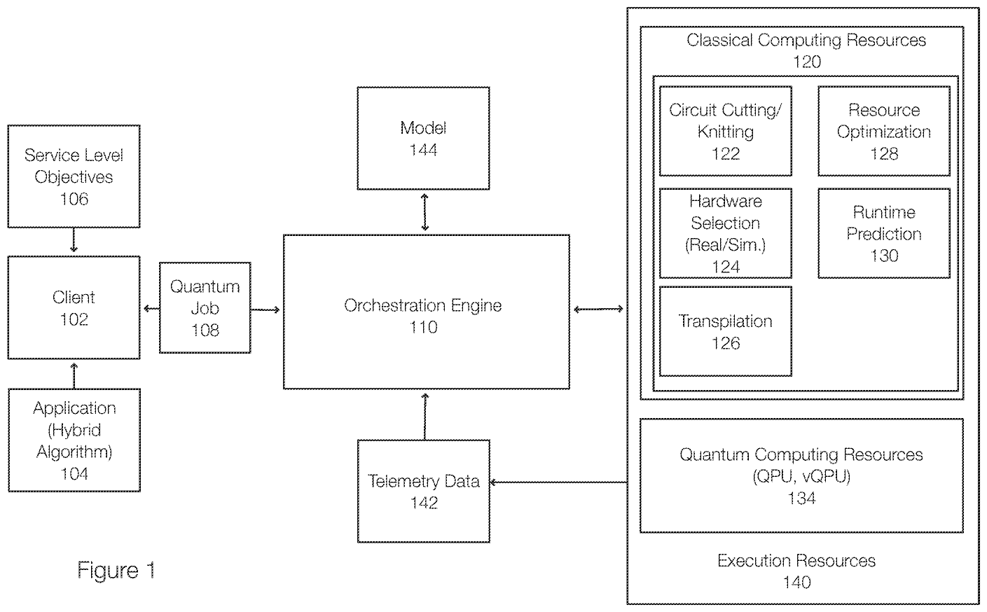

FIG. 1 discloses aspects of orchestrating a quantum job. In one example, a quantum job 108 may be generated by a hybrid application 104. The hybrid application 104 is an application that may require the use of both classical computing resources 120 and quantum computing resources 134. The orchestration of the quantum job 108 may be performed by an orchestration engine 110 that includes or has access to execution resources 140, which includes classical computing resources 120 and quantum computing resources 134. The classical computing resources 120 (e.g., servers, nodes, containers, clusters, virtual machines) may include include processors, memory, and the like. As previously stated, some aspects of the quantum job 108 may be executed in classical computing systems 120 and other aspects may be executed in quantum computing resources 134 (simulated or real). When quantum computing resources 134 are required, the hybrid application 104 may generate and submit a quantum job 108 to the orchestration engine 110. Results of executing the quantum job may be returned to the client 102 (or the application 104). Other aspects of the hybrid application 104 that do not require quantum computing may be performed in classical computing systems with or without the aid of the orchestration engine.

In FIG. 1, a client 102 (e.g., a computing device that may receive user input) may submit a quantum job 108, which may be associated with service level objectives 106 and a hybrid application 104, to an orchestration engine 110. The orchestration engine 110 is configured to orchestrate the execution of the quantum job 108 in accordance with the service level objectives 106.

The orchestration engine 110 may orchestrate the operations involved in executing the quantum job. The actions or operations orchestrated by the orchestration engine 110 may include circuit cutting/knitting 122 operations, resource optimization 128 operations, hardware selection 124 operation, runtime prediction 130 operations, transpilation 126 operations, or the like or combination thereof.

In effect, the orchestration engine 110 may guide the quantum job 108 through a quantum pipeline such that the output of each stage is directed to the input of the next stage. Examples of stages or operations that may be performed on a quantum job include cutting, cutting point prediction, transpilation, knitting, resource optimization, runtime prediction, or the like or combinations thereof.

Once the quantum circuit or quantum subcircuits are prepared for execution, these circuits are deployed to or placed in the quantum computing resources 134, which may be simulated or real. The results of executing the quantum circuits in the quantum computing resources 134 may also be collected by the orchestration engine 110 and returned to the client 102.

When the orchestration engine 110 is performing, by way of example, a cutting operation, the orchestration engine 110 may use a model 144 to optimize the cutting operation. The model 144 may be a recurrent machine learning model that is configured to identify cutting points in the quantum circuit. When a quantum circuit is in the form of a directed acyclic graph (DAG), by way of example, the cutting points may correspond to specific layers. The model 144 may generate probabilities, for each layer of the DAG, that represent the likelihood of a successful cut. Layers that are unlikely to result in a successful cut can be discarded. Embodiments of the invention thus optimize the cutting operation by eliminating potential solutions to the cutting problem from consideration or from processing. This improves the efficiency of the cutting operation by eliminating solutions to the combinatorial problem of cutting the quantum circuit.

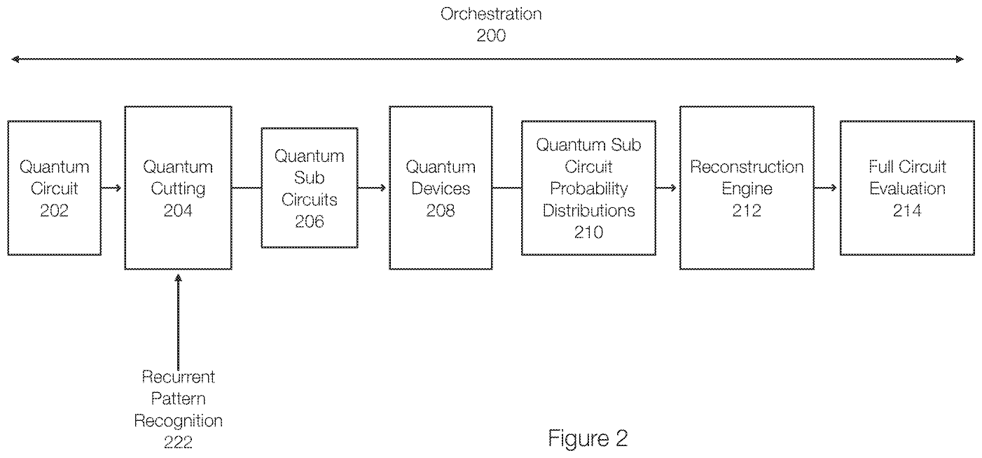

FIG. 2 discloses aspects of orchestrating the execution of a quantum circuit and illustrates examples of orchestration actions or operations. In FIG. 2, an orchestration engine performs orchestration 200 that may begin with receipt of a quantum job or circuit and end with providing results of executing the quantum circuit. As shown in FIG. 2, a quantum circuit 202 is provided to quantum cutting 204. When cutting the quantum circuit 202 at quantum cutting 204, recurrent pattern recognition 222 is performed to optimize the cutting operation. Identifying likely cutting points is an example of recurrent pattern recognition.

Recurrent pattern recognition 222 includes evaluating a representation of the quantum circuit using a trained machine learning model. More specifically, the quantum circuit 202 may be represented as a directed acyclic graph (DAG). The machine learning model may be configured to generate a probability of success if a cut is performed at a particular layer of the DAG. Layers of the DAG that have low probability (e.g., below a threshold probability) are discarded as potential solutions to the cutting problem. The recurrent pattern recognition 222 is an example of a model that is configured to determine the likelihood of successfully cutting the quantum circuit at each layer in the DAG. This optimizes the quantum cutting 204 (the cutting operation) by reducing the number of solutions that are considered.

Once some of the solutions have been discarded, a solution is selected from the remaining solutions and a cutting operation is performed at 204. Cutting 204 the quantum circuit 202 generates quantum subcircuits 206 that are executed at quantum devices 208 (real or simulated). Once the quantum subcircuits 206 are generated, runtime prediction (e.g., estimating resources required for the quantum subcircuits 206 and/or execution time) may be performed on each of the quantum subcircuits 206 such that resource optimization 222 can be performed. Once an execution plan is generated that reflects the resource optimization, the quantum subcircuits 206 are submitted to the quantum devices 208 (real and/or simulated) in accordance with the execution plan. The outputs of the executions may include quantum subcircuit probability distributions 210.

Executing a quantum circuit is often performed by executing the circuit in a quantum system for a predetermined number of shots. The output is a collection of shot results which reflect an underlying probability distribution. Thus, the outputs of executing the quantum subcircuits includes the probability distributions 210.

Next, a knitting operation is performed by a reconstruction engine 212. The reconstruction engine 212 combines the outputs (e.g., the various probability distributions) of executing the quantum subcircuits 206 to determine the output (the probability distribution) of the original quantum circuit 202. This allows an evaluation 214 of the full or original quantum circuit to be performed. The results or evaluation can be returned to the client or to the hybrid application.

As previously stated, embodiments of the invention relate to optimizing the cutting operation. In one embodiment, a recurrent ML (machine learning) model that identifies circuit patterns on a DAG representation of a quantum circuit is configured to predict how likely a cutting point in the quantum circuit is to produce good results. This helps optimize the cutting operation by discarding solutions that are unlikely to be good and potentially makes the execution of the cutting operation (and circuit execution) more efficient.

Quantum circuits can be represented by a DAG [symbol] =( [symbol] , [symbol] ), where [symbol] are the vertices that represent quantum gates of the circuit and [symbol] are the edges that represent qubit dependencies by joining one quantum gate to the other along the qubits affected by the gates. A circuit DAG can be split in layers, where the first layer represents the vertices without any predecessors. Subsequent layers are defined by recursively “removing” the first layer and taking the first layer of the resulting DAG.

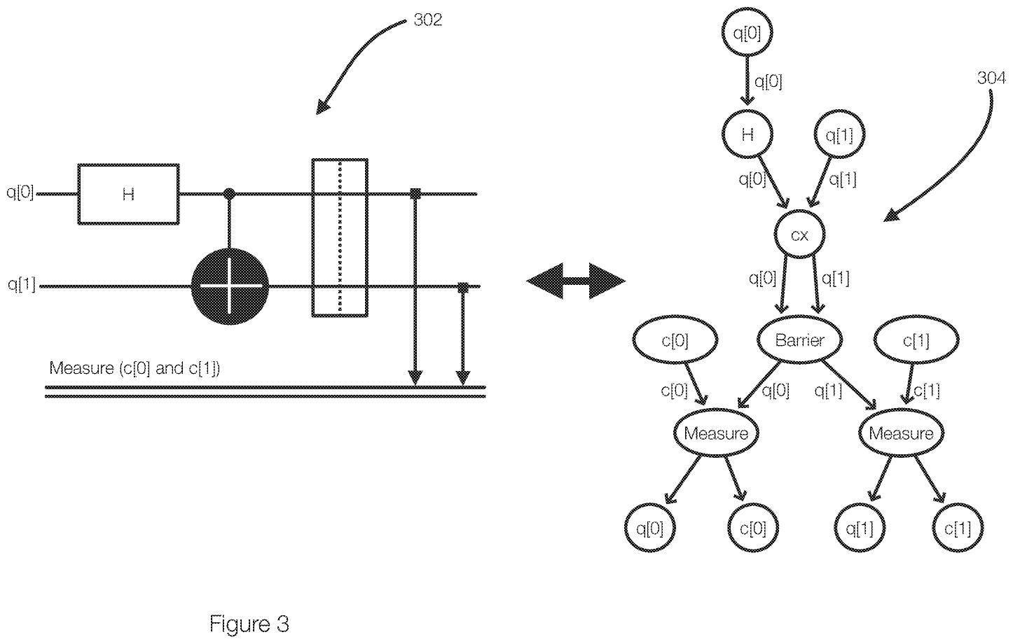

FIG. 3 discloses aspects of representing a quantum circuit as a DAG. FIG. 3 illustrates a quantum circuit 302 (e.g., a BELL circuit). The DAG 304 is an example DAG representation of the circuit 302.

Embodiments of the invention include a graph embedding solution (e.g., Graph2Vec) at layer [symbol] ᵢ of the DAG that transforms a subgraph of the DAG including layers (e.g., layers { [symbol] ᵢ₋ₖ, . . . , [symbol] ᵢ, . . . , [symbol] ᵢ₊ₖ}) into a numerical, vectorial representation, Li, of dimension d. The values k and d are hyper-parameters in embodiments of the invention.

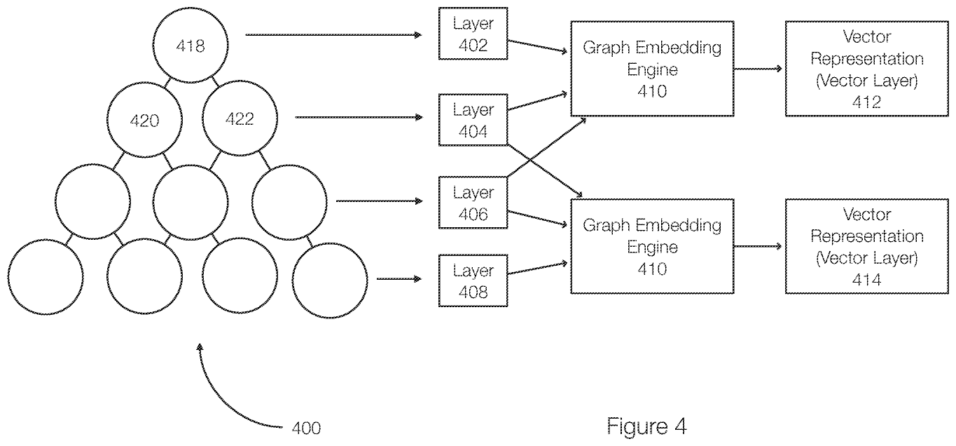

FIG. 4 discloses aspects of graph embedding. FIG. 4 illustrates a DAG 400 that includes layers 402, 404, 406, and 408. As previously stated, the layer 402 includes the nodes or vertices that do not have a predecessor. By removing the vertex 418, the vertices 420 and 422 do not have any predecessors and are included in the layer 404. The layers 406 and 408 are similarly determined.

To generate the vector representation of a layer (represented as vector representations or vector layers) 412 and 414, a graph embedding engine 410 is configured to transform a subgraph of DAG layers into a numerical vectorial representation or into a vector layer. Thus, multiple layers of the DAG are represented by a vector layer in one embodiment. However, each vector layer has a corresponding DAG layer. Thus, each DAG layer [symbol] ᵢ has a corresponding vector layer Lᵢ. In this example, the vector representation 412 is a vectorial representation of a subgraph of DAG layers that includes the layer 404. The vector representation 412 is generated by considering a subgraph of the graph 400. The subgraph of the DAG 400 considered by the graph embedding engine 410 includes the layers 402, 404, and 406. Similarly, the vector representation 414 represents the layer 406 and is generated from a subgraph of the DAG 400 that includes the layers 404, 406, and 408.

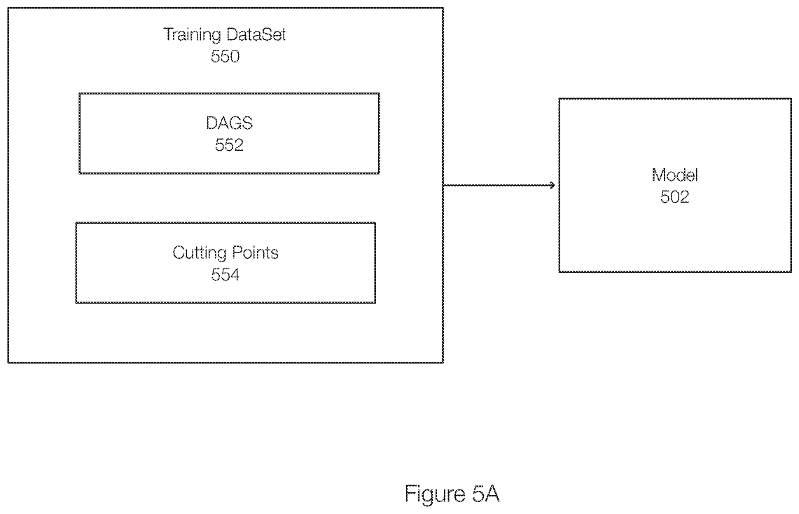

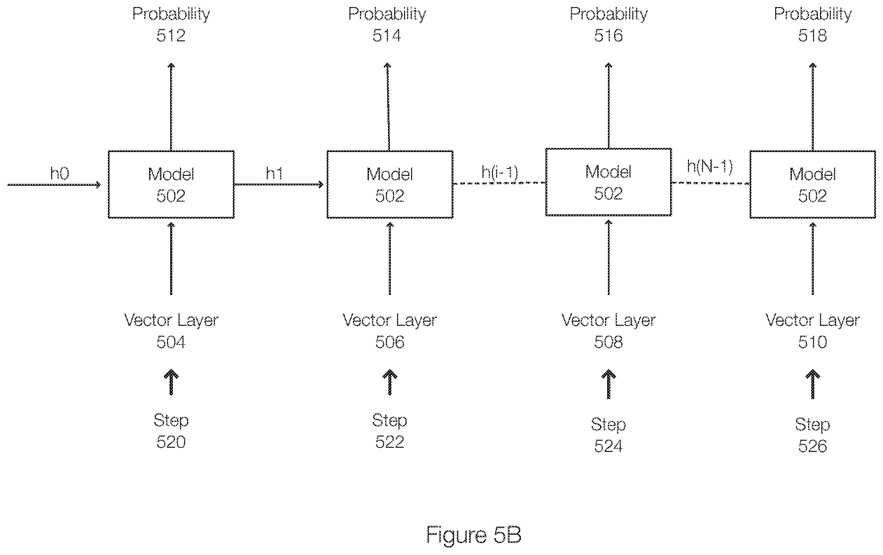

FIG. 5A discloses aspects of training a machine learning model that is configured to generate probabilities for potential cutting points in a quantum circuit. FIG. 5A illustrates a model 502, which may be a recurrent machine learning model, that is trained using a training dataset 550. The training dataset includes DAGs 552 and their cutting points 554. The DAGs 552 represent quantum circuits that have been successfully cut previously. The cutting points 554 for the DAGs 552 in the training dataset 550 are labeled with a probability of 1 and the other layers are labelled with a probability of 0. Embeddings of size k are obtained and the model 502 traversed each of the DAGs from beginning to end. This allows the model 502 to be trained based on vector representations and labeled probabilities. The model 502 can thus, in effect, recognize recurrent patterns when presented with a new DAG.

FIG. 5B discloses aspects predicting cutting points in a new quantum circuit. More specifically, the model 502, once trained, can receive vector layers of a new quantum circuit or from its DAG representation and generate probabilities for each of the layers of the quantum circuit. The probabilities represent the likelihood of obtaining a cut at a particular cutting location.

A recurrent model 502 (model [symbol] ) with m steps (the model is executed recursively m times) is an example of the model 502. In the recurrent model 502, each step i, represented as steps 520, 522, 524, and 526 takes as input the embeddings, Lᵢ. Thus, the vector layer 502 is the embedded layer L₁ in the step 520 that was generated from a subgraph of the DAG. The model 502 generates a probability 512 for cutting the quantum circuit at the layer DAG layer [symbol] ₁ corresponding to the vector layer 504 Lᵢ. As previously stated, the vector layer 504 is a vector representation of a subgraph of the DAG of the quantum circuit being processed.

In the step 522, the model 502 receives vector layer 506 (L₂) and generates a probability 514 associated with cutting the quantum circuit at layer [symbol] ₂ corresponding to the vector layer 506. Similarly, the probabilities 516 and 518 are generated for the vector layers 508 and 510 (e.g., vector layers Lᵢ and L_{N}), which correspond to the DAG layers [symbol] ᵢ and [symbol] _{N}. The value N is the total number of layers of the DAG. The measure of goodness (the probabilities) relates to how similar graphs (or quantum circuits) have been successfully cut in past executions of the cutting heuristic.

Thus, the model 502 moves from one vector layer to the next vector layer generated from the layers of the DAG, in a rolling window fashion. Stated differently, each successive instance or use of the model 502 takes the next set of k layers as input, which are embedded as a vector layer) for the model 502, where another cutting probability is obtained. At the end of the process until reaching N layers, cutting probability values (e.g., probabilities 512, 514, 516, and 518) are obtained for each layer of DAG [symbol] . AS illustrated in FIG. 5B, each time the model 502 is used, a hidden state (e.g., h0, h1, h(i-1) . . . h(N-1) is also provided. The hidden state is representative of knowledge from previous steps.

At inference time, the trained mode 502 [symbol] may be used to yield probabilities of a cut happening at all layers of an unseen or new quantum circuit. The obtained probabilities are provided as input to the cutting operation so that the cutting operation or algorithm takes the probabilities into account in optimizing the cutting operation. Layers with a probability below a threshold probability may be discarded from consideration as solutions to the cutting problem.

The model may also provide or output additional information. For example, if the model returns a cutting probability higher than a given threshold for any layer of the circuit's DAG, then the circuit can be cut at the corresponding location(s). If the model does not return a cutting probability higher than the given threshold for any layer of the circuit's DAG, then the circuit cannot or may not benefit from being cut in some embodiments. When the circuit cannot be cut at a location, the cutting algorithm is not invoked and the cost of computation related to the cutting algorithm is avoided.

The model may also aid in determining how many subcircuits can potentially be obtained by cutting the circuit. The number of subcircuits, in one embodiment, is related to the number of layers for which the model 502 yields a cutting probability higher than a given threshold probability.

If the model 502 provides minimum and maximum probabilities that are at the edges (minimum or maximum edges) for the cuts then the model 502 could be used to get a solution that is suitable directly from the probabilities.

Embodiments of the invention include embedding a quantum circuit's DAG layers into numerical, vectorial representations. Embodiments of the invention relate to training a recurrent machine learning model (or other model) that yields the probability of cutting a circuit at one of the DAG layers, taking as input a sequence of layer embeddings. This allows the cutting probability at the layers of the quantum circuit to be inferred.

Providing a set of probabilities to a cutting algorithm allows the cutting algorithm to run more efficiently, including when viewed as a combinatorial problem. For example, certain cuts do not need to be considered given the inferred probabilities of being a successful cut. This reduces the complexity of the combinatorial problem.

The model 502 also allows the number of subcircuits that can be generated by cutting the circuit to be determined or estimated prior to running the cutting algorithm.

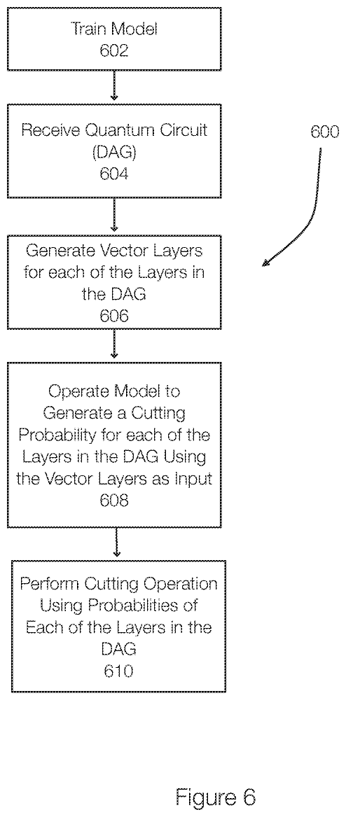

FIG. 6 discloses aspects of a cutting operation that accounts for patterns in successful cutting operations performed on other quantum circuits. The method 600 may include acts or steps that can be performed independently or separately. For example, training 602 a model, such as a recurrent model, may be performed prior to identifying cutting points in a quantum circuit. The model may be trained initially and the training can be updated as additional data is collected.

In the method 600, a quantum circuit is received 604. If necessary, the quantum circuit is converted to a DAG. Although embodiments of the invention are discussed with respect to DAG layers, embodiments of the invention are not limited thereto.

The acts or steps 606 and 608 can be performed in different manners. Because the model is a recurrent model, it may be possible to generate 606 vector layers for all of the DAG layers prior to inputting the vector layers into the recurrent model. However, the vector layers may be generated as needed or on a rolling basis. Thus, the first vector layer is generated and input to the model. Once the model generates a probability for the first layer of the DAG, the second vector layer may be generated and input to the recurrent model. For each layer, the model is operated or executed 608 to generate a cutting probability for the respective layer in the DAG.

Once the probabilities are generated for all of the layers of the DAG, the cutting operation may be performed 610 using the probabilities of the layers as input to the cutting operation. Further, because the probabilities of all layers of the DAG are predicted, the number of subcircuits and their cutting locations can be estimated or predicted. However, the cutting operation is not bound by the output of the recurrent model.

For example, if a DAG has 8 layers with a probability suggesting that a cut would be successful at these layers or at these cutting points, the cutting operation may elect to cut at one of the cutting points, two of the cutting points, or the like. The cutting operation may also perform cuts at other locations. The determination of which cutting points to use and how many subcircuits to generate may depend on resource availability, service level objectives, or the like.

In another example, probabilities that are near maximums or minimums may be selected as a good solution without further analysis of other potential solutions as these probabilities suggest a successful and good cutting solution.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, hybrid-classical application operations, quantum circuit operations, quantum circuit execution operations, quantum circuit cutting operations, resource consumption estimation operations, quantum circuit knitting operations, telemetry operations, machine learning model operations (e.g., that generate predictions or inferences), modelling operations, recurrent modelling operations; probability related operations, cutting optimization operations, or the like or combination thereof. These operations may, in some examples, be referred to as quantum operations.

Example cloud computing environments, which may or may not be public, include storage environments that may provide functionality for one or more clients or systems. Another example of a cloud computing environment is one in which quantum operations and/or quantum services may be performed on behalf of one or more clients, applications, or users. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment. The cloud environment may also include quantum environments including vQPUs, QPU, other accelerators, or the like.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data or circuits. Such clients may comprise physical machines, containers, or virtual machines (VMs).

Particularly, devices in the operating environment, such as classical components of hybrid classical-quantum systems, may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

It is noted that any operation(s) of any of these methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a quantum circuit at an orchestration engine, wherein the orchestration is configured to orchestrate execution of the quantum circuit, generating a graph that corresponds to the quantum circuit, wherein the graph includes graph layers, generating a vector layer for each of the graph layers, providing the vector layers as input to a recurrent model, wherein the recurrent model is configured to generate a probability for each of the vector layers, wherein each of the vector layers having a probability higher than a threshold probability is identified as a cutting point, and performing a cutting operation to cut the quantum circuit at one or more of the cutting points identified by the recurrent model, wherein each of the cutting points corresponds to a graph layer of the graph.

Embodiment 2. The method of embodiment 1, further comprising training the model using a dataset that includes a plurality of graphs corresponding to previously cut quantum circuits and successful cutting locations of those graphs.

Embodiment 3. The method of embodiment 1 and/or 2, wherein the graph comprises a directed acyclic graph.

Embodiment 4. The method of embodiment 1, 2, and/or 3, further comprising generating each of the vector layers using a subgraph of the graph, wherein the subgraph includes k consecutive layers of the graph.

Embodiment 5. The method of embodiment 1, 2, 3, and/or 4, wherein the k consecutive layers includes at least one layer before a current layer of the graph and at least one layer after the current layer.

Embodiment 6. The method of embodiment 1, 2, 3, 4, and/or 5, further comprising performing the cutting operation based on specific probabilities, wherein the specific probabilities include probabilities that are close to maximums and minimums, wherein the cutting locations correspond to the layers associated with probabilities that are close to maximums.

Embodiment 7. The method of embodiment 1, 2, 3, 4, 5, and/or 6, further comprising determining how many subcircuits to generate based on the cutting points.

Embodiment 8. The method of embodiment 1, 2, 3, 4, 5, 6, and/or 7, wherein a probability suggests a cutting point when the probability for the corresponding vector layer is above a threshold probability.

Embodiment 9. The method of embodiment 1, 2, 3, 4, 5, 6, 7, and/or 8, further comprising executing quantum subcircuits resulting from cutting the quantum circuit.

Embodiment 10. The method of embodiment 1, 2, 3, 4, 5, 6, 7, 8, and/or 9, further comprising determining whether the quantum circuit can be cut based on the probabilities prior to performing the cutting operation.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

Embodiment 13. A system comprising a processor and memory configured to perform the operations, methods, or processes, or any portion of any of these, or any combination thereof disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, or agent, may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, herein, may take the form of, or include, or be implemented on, or hosted by, a physical computing device, As well, where any of the aforementioned elements comprise or consist of a virtual machine (VM) or a container, that VM or container may constitute a virtualization of any combination of the physical components disclosed herein.

In a physical computing device includes a memory which may include one, some, or all, of random-access memory (RAM), non-volatile memory (NVM) such as NVRAM for example, read-only memory (ROM), and persistent memory, one or more hardware processors, non-transitory storage media, Ul device, and data storage. One or more of the memory components of the physical computing device may take the form of solid-state device (SSD) storage. As well, one or more applications may be provided that comprise instructions executable by one or more hardware processors to perform any of the operations, or portions thereof, disclosed herein. The physical device may be an example of a classical computing system that may be part of a hybrid computing system. A quantum processing system or unit may also be included in the hybrid computing system.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a quantum circuit at an orchestration engine, wherein the orchestration is configured to orchestrate execution of the quantum circuit;
generating a graph that corresponds to the quantum circuit, wherein the graph includes graph layers;
generating a vector layer for each of the graph layers; and
providing the vector layers as input to a recurrent model, wherein the recurrent model is configured to generate a probability for each of the vector layers, wherein each of the vector layers having a probability higher than a threshold probability is identified as a cutting point; and
performing a cutting operation to cut the quantum circuit at one or more of the cutting points identified by the recurrent model, wherein each of the cutting points corresponds to a graph layer of the graph.

2. The method of claim 1, further comprising training the model using a dataset that includes a plurality of graphs corresponding to previously cut quantum circuits and successful cutting locations of those graphs.

3. The method of claim 1, wherein the graph comprises a directed acyclic graph.

4. The method of claim 1, further comprising generating each of the vector layers using a subgraph of the graph, wherein the subgraph includes k consecutive layers of the graph.

5. The method of claim 4, wherein the k consecutive layers includes at least one layer before a current layer of the graph and at least one layer after the current layer.

6. The method of claim 1, further comprising performing the cutting operation based on specific probabilities, wherein the specific probabilities include probabilities that are close to maximums and minimums, wherein the cutting locations correspond to the layers associated with probabilities that are close to maximums.

7. The method of claim 1, further comprising determining how many subcircuits to generate based on the cutting points.

8. The method of claim 1, wherein a probability suggests a cutting point when the probability for the corresponding vector layer is above a threshold probability.

9. The method of claim 1, further comprising executing quantum subcircuits resulting from cutting the quantum circuit.

10. The method of claim 1, further comprising determining whether the quantum circuit can be cut based on the probabilities prior to performing the cutting operation.

11. A non-transitory storage medium having stored therein instructions that are executable by one or more hardware processors to perform operations comprising:
receiving a quantum circuit at an orchestration engine, wherein the orchestration is configured to orchestrate execution of the quantum circuit;
generating a graph that corresponds to the quantum circuit, wherein the graph includes graph layers;
generating a vector layer for each of the graph layers; and
providing the vector layers as input to a recurrent model, wherein the recurrent model is configured to generate a probability for each of the vector layers, wherein each of the vector layers having a probability higher than a threshold probability is identified as a cutting point; and
performing a cutting operation to cut the quantum circuit at one or more of the cutting points identified by the recurrent model, wherein each of the cutting points corresponds to a graph layer of the graph.

12. The non-transitory storage medium of claim 11, further comprising training the model using a dataset that includes a plurality of graphs corresponding to previously cut quantum circuits and successful cutting locations of those graphs.

13. The non-transitory storage medium of claim 11, wherein the graph comprises a directed acyclic graph.

14. The non-transitory storage medium of claim 1, further comprising generating each of the vector layers using a subgraph of the graph, wherein the subgraph includes k consecutive layers of the graph.

15. The non-transitory storage medium of claim 4, wherein the k consecutive layers includes at least one layer before a current layer of the graph and at least one layer after the current layer.

16. The non-transitory storage medium of claim 11, further comprising performing the cutting operation based on specific probabilities, wherein the specific probabilities include probabilities that are close to maximums and minimums, wherein the cutting locations correspond to the layers associated with probabilities that are close to maximums.

17. The non-transitory storage medium of claim 11, further comprising determining how many subcircuits to generate based on the cutting points.

18. The non-transitory storage medium of claim 11, wherein a probability suggests a cutting point when the probability for the corresponding vector layer is above a threshold probability.

19. The non-transitory storage medium of claim 11, further comprising executing quantum subcircuits resulting from cutting the quantum circuit.

20. The non-transitory storage medium of claim 11, further comprising determining whether the quantum circuit can be cut based on the probabilities prior to performing the cutting operation.
